(19) United States
(12) Patent Application Publication
(10) Pub. No.: US 2008/0199737 A1
(43) Pub. Date: Aug. 21, 2008

(54) ELECTROCHEMICAL SUPERCAPACITOR/LEAD-ACID BATTERY HYBRID ELECTRICAL ENERGY STORAGE DEVICE

(75) Inventors: Samvel Avakovich Kazaryan, Troitsk (RU); Gamir Galievich Kharisov, Troitsk (RU); Vladimir Alexandrovich Kazarov, Troitsk (RU); Sergey Nikolaevich Razumov, Moscow (RU); Sergey Vitalievich Litvinenko, Zelenograd (RU)

Correspondence Address: STANDLEY LAW GROUP LLP, 495 METRO PLACE SOUTH, SUITE 210, DUBLIN, OH, 43017, US

(73) Assignee: Universal Supercapacitors LLC, Columbus, OH (US)

(21) Appl. No.: 12/032,198

(22) Filed: Feb. 15, 2008

Related U.S. Application Data
(60) Provisional application No. 60/890,343, filed on Feb. 16, 2007.

(51) Int. Cl. H01M 16/00

(52) U.S. Cl. 429/9

(57) ABSTRACT

A hybrid lead-acid battery/electrochemical capacitor electrical energy storage device. The lead-acid battery and electrochemical capacitor reside in the same case and are electrically connected. Preferably, a hybrid device of the present invention includes at least one non-polarizable positive electrode, at least one non-polarizable negative electrode, and at least one polarizable electric double layer negative electrode. Separators reside between the electrodes and the separators and electrodes are impregnated with an aqueous sulfuric acid electrolyte. A hybrid device of the present invention exhibits high power characteristics.

### BACKGROUND OF THE INVENTION

The present invention is directed to a hybrid electrical energy storage device having both lead acid battery and electrochemical supercapacitor elements. More particularly, the present invention is directed to such a hybrid electrical energy storage device wherein the lead acid battery and electrochemical supercapacitor elements are disposed within the same case and are electrically connected.

The current pace of development of many advanced technologies has placed increased requirements on the operational parameters of various chemical power sources that are commonly used therein. To comply with these increased requirements, the operating parameters of current chemical power sources have been continuously improved. Much of this improvement has occurred in the areas of design and technology of manufacture. As a result, new power sources have been developed that offer improved technical and operational parameters.

Nonetheless, further enhancement of chemical power source capabilities has continued to be of particular importance. To this end, electrochemical supercapacitors, such as electric double layer (EDL) supercapacitors, have experienced increased use in recent years. This increased use is due, in large part, to the robust power characteristics associated with many modern supercapacitors. Unfortunately most of these modern supercapacitors are also burdened with low specific energy parameters and high cost. Despite the fact that the technology of manufacture and the overall performance characteristics of modern supercapacitors continues to improve, the cost of storing energy using even the best of such supercapacitors is quite high in comparison with the cost of storing energy using modern batteries. Consequently, the negative characteristics of supercapacitors typically limit the scope of their application to situations where high discharge power is paramount.

Per current practice, therefore, when it is desired or necessary to provide a low cost power source possessed of both high specific energy and high power, a battery/supercapacitor hybrid system is typically used. Known systems of such variety commonly comprise a battery with high specific energy connected in parallel with an EDL capacitor with high charge and discharge power. Such hybrid electrical energy storage systems typically exhibit high discharge power and high energy, and may be used to provide great discharge power, such as in conjunction with devices for the starting of various engines, in electric power sources of hybrid vehicles, and in various electric circuits.

A “battery+capacitor” system provides a number of beneficial parameters. Furthermore, the use of supercapacitors together with a battery considerably enhances the service and cycle life of the battery. Most often, in order to obtain a sufficiently high discharge power, a “lead-acid battery+EDL supercapacitor” system is used. Such a system configuration is most preferable, since, apart from the power parameters, the cost parameter of the power source (the supercapacitor and the system as a whole) is of paramount importance. Inasmuch as high-discharge lead-acid batteries currently provide energy at the least cost, and the technology of their manufacture is adequately developed, simple, and inexpensive, it can be readily understood that a hybrid lead-acid battery/EDL capacitor device can be made to possess excellent power, energy and cost parameters.

In order to produce a power supply with high discharge power, low impedance and low internal resistance values are desirable. To this end, manufacturers of modern batteries typically use thin positive and negative electrodes and a thin separator in their storage battery designs. The use of thin electrodes makes it possible to increase the visible surface area of the electrodes which, correspondingly, brings about a decrease of the internal resistance and growth of the power parameters of the batteries. However, along with a decrease in electrode and separator thickness, comes an increase in the cost of energy storage. Additionally, the service and cycle life of such batteries are generally substantially reduced. Batteries with thin electrodes also require precision modes of charge and considerable operational maintenance.

Despite such drawbacks, development and manufacture of lead-acid batteries with thin electrodes has accelerated in recent years due to a desire to increase the power parameters thereof. Such batteries are commonly used, for example, to start high-output carbureted and diesel engines, and as an electric power source in modern hybrid vehicles.

The internal resistance of batteries and, in particular, lead-acid batteries, also depends to a great extent on the state of their charge and the temperature of the environment in which they operate. The internal resistance of a battery at a low-level state of charge has an increased value in comparison to the internal resistance of a fully charged battery, and this characteristic limits the power parameters of partially discharged batteries. Such behavior in a lead-acid battery is primarily related to the properties of its negative electrode. More specifically, during discharge of a lead-acid battery by high discharge currents, the surface layers of its electrodes are substantially discharged. This results in an increase in the electric resistance between particles of the active mass in the near surface area of the negative electrode(s). In particular, the greatest increase in electric resistance occurs in a negative electrode of spongy lead, and this increase in electrode resistance also brings about an increase in the internal resistance of the battery as a whole. Such behavior manifests itself to the greatest extent when lead-acid batteries are operated in low temperature environments and, consequently, considerably limits the scope of their application.

Due to electrode self-discharge, another drawback of lead-acid batteries is sulfation of the near-surface layer of their negative electrodes during storage in a fully charged state—which may occur even when such batteries are stored for only a relatively short period of time. With sulfation, a thin layer of lead sulfate forms and greatly increases the battery's internal resistance, thereby resulting in a decrease of its discharge power (and some insignificant losses of the battery's Coulomb capacity). This drawback can result in operational failures such as the inability of a battery to start an engine, even when the battery has been in service for only a short time.

In order to enhance the reliability of engine starting or to provide for high discharge power, starters (and similar devices) must often employ batteries with excess capacity, or use several batteries connected in parallel. Such an approach may provide a partial solution to the problem of reliable engine starting. However, this solution also results in an increase in the weight, volume and price of the batteries used, as well as the cost of their operation.

A system based on batteries with low Coulomb capacity and a supercapacitor connected in parallel can provide sufficient energy and, therefore, a practicable solution to the problem of reliable engine starting. During high power discharge of such a system, the capacitor delivers most of the energy to the load since the internal resistance of the capacitor is significantly lower than that of the battery. After starting of the engine, the capacitor is quite promptly charged from the battery and may produce a repeated start of the engine without any additional charge of the system. Since the voltage of the battery depends very little on the state of its charge, and during each start a small amount of electricity is used (in relation to the Coulomb capacity of the battery), such a system is capable of producing several reliable engine starts in a row without requiring further charging.

Another advantage of the “battery+supercapacitor” system is that it is not necessary to fully charge the battery in order to provide for a reliable engine start. This implies that during a long storage of such a system (when the battery is partially discharged and, as was mentioned above, the battery's power parameters decrease), its high power discharge capability and ability to reliably start an engine will be retained. This is noteworthy because frequent overcharging of lead-acid batteries leads to increased corrosion of the positive electrode grids, partial breakdown of the porous structure of the active mass of the positive and negative electrodes, and causes a reduction in the service and cycle life of the batteries. Since a “battery+supercapacitor” system allows for battery operation in a partially charged state, such a system provides for improved battery cycle and service life as compared with a separately operating battery.

It is the power parameters of the supercapacitor, not the battery, that are responsible for producing the high power discharge capabilities of a “battery+supercapacitor” system. As such, a “battery+supercapacitor” system may use batteries with thick electrodes, thereby further improving cycle and service life and allowing for the lowest possible cost.

In practice, current “battery+supercapacitor” systems most often employ individual capacitors, the terminals of which are connected to the terminals of the battery by means of wires of large cross-section. Such a “battery+supercapacitor” system has at least the following drawbacks: (a) external connection of the battery to the supercapacitor results in an increase in internal resistance, a decrease in power parameters, and a higher system cost; (b) the system occupies a large space and has low specific (by volume) power and energy parameters; (c) for mass production of such a system, it is necessary to have individual battery and supercapacitor production facilities, which complicates the manufacturing technology and further increases the cost of the system.

Another known but less common prototype “battery+supercapacitor” electrical energy storage device uses a non-aqueous electrolyte and a lithium-ion battery with non-polarizable positive and negative electrodes. These components have a rather high cost, and the electrolytes used can render the device somewhat dangerous.

### SUMMARY OF THE INVENTION

A heterogeneous electrochemical supercapacitor/lead-acid battery (i.e., “hybrid”) device of the present invention overcomes the drawbacks described above with respect to known lead-acid battery/supercapacitor systems. Further, in contrast to the aforementioned lithium-ion battery/supercapacitor type hybrid device, the cost of a hybrid device of the present invention is considerably lower due to the low cost of its lead-acid battery positive and negative electrodes and its aqueous sulfuric acid electrolyte. As a further benefit, the use of an aqueous sulfuric acid electrolyte makes a hybrid device of the present invention safer than the lithium-ion prototype device. A hybrid device of the present invention may also be used at higher temperatures.

A hybrid device of the present invention may be used, for example, as: a power source to start internal combustion engines; an auxiliary actuation device in hybrid vehicles; a power supply for stationary and mobile means of communications; a power supply of electric vehicles; and a power supply of electronic equipment. Numerous other uses are also obviously possible.

The use of a hybrid device of the present invention is an optimal solution to obviate the afore-mentioned drawbacks of know hybrid power sources. The present invention is further explained by the following exemplary embodiments and methods of manufacture thereof.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIGS. 1a-3b show variants of a hybrid device of the present invention;

FIG. 4 graphically illustrates the dependence of discharge Coulomb capacity of the cell of a lead-acid battery and the cells of several hybrid devices of the present invention on the average specific power of cell discharge;

FIG. 5 graphically depicts the dependence of the discharge energy of the cell of a lead-acid battery and the cells of several hybrid devices of the present invention on the average specific power of cell discharge;

FIG. 6 graphically illustrates the dependence of the voltage of the cell of a lead-acid battery and the cells of several hybrid devices of the present invention on the time of storage of the cells at room temperature;

FIG. 7 graphically depicts the dependence of the specific |Z| impedance of the cell of a lead-acid battery and the cells of several hybrid devices of the present invention on voltage during a 5-hour charge period and 5-hour discharge period of the cells;

FIG. 8a graphically illustrates the dependence of the voltage (U) and discharge current (I) of a cell of a hybrid device of the present invention on time, during its multiple discharge (a);

FIG. 8b graphically depicts the dependence of the voltage (U) and discharge current (I) of the cell of FIG. 6a on time, in its 4th and 5th discharges (b); and

FIG. 9 graphically represents the dependence of the average power of discharge (W) of the cell of the hybrid device of FIGS. 6a and 6b on the number (N) of discharge pulses.

### DETAILED DESCRIPTION OF EXEMPLARY EMBODIMENTS

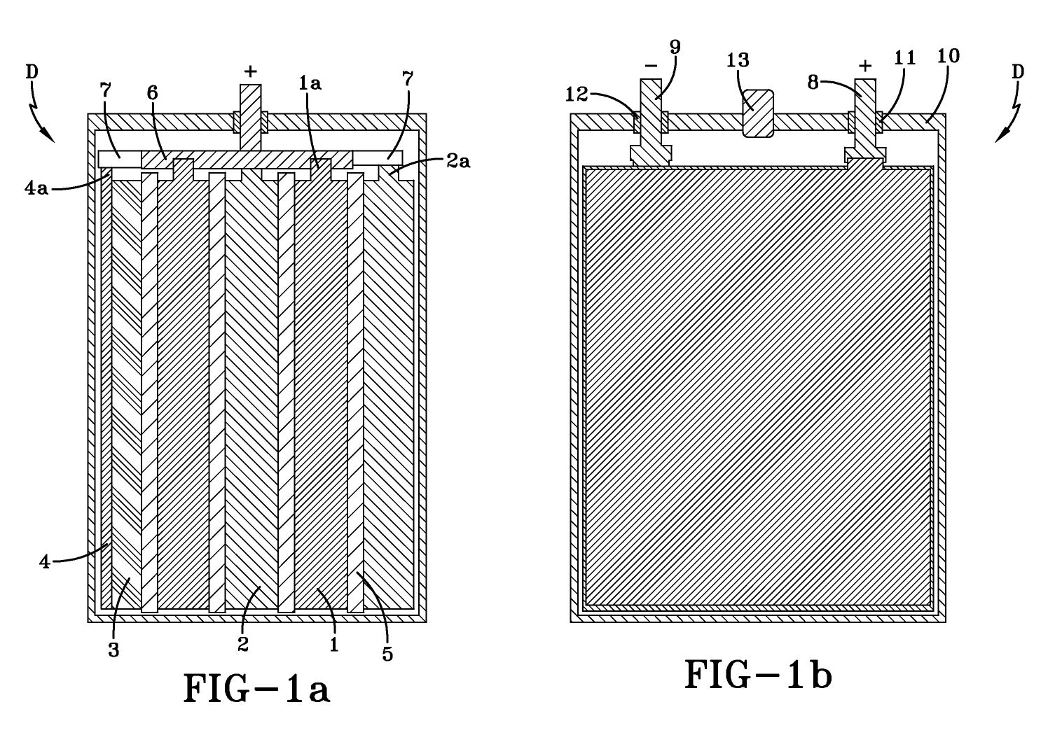

An exemplary hybrid device D of the present invention is shown in FIG. 1a to include a pair of positive electrodes 1 made of lead dioxide (PbO₂) active material. One positive electrode 1 serves as the positive electrode of the lead-acid battery portion of the device D and the other as the positive (non-polarizable) electrode of the heterogeneous electrochemical supercapacitor (HES) portion of the device. The negative electrodes of the device D include a pair of lead-acid battery negative electrodes 2 made of spongy lead active material, and a HES negative electrode 3 made of an active material based on activated carbon powders and binding polymers.

A negative electrode current collector 4 is also present. A current lead 4a of the current collector 4 (associated with the HES negative electrode 3) is connected with the current leads 2a of the lead-acid battery negative electrodes 2. The positive and negative electrodes of the hybrid device D are separated by porous separators 5. The current leads 1a of the positive electrodes 1 are preferably connected by a bus 6, which may be made of a lead alloy. The current leads 2a of the lead-acid battery negative electrodes 2 and the current lead 4a of the current collector 4 of the HES negative electrode 3 are also preferably connected by a bus 7, which may also be made of a lead alloy.

The hybrid device D has positive and the negative lead alloy terminals 8, 9 that are connected to the buses 6, 7 of the positive and negative electrodes, respectively. The electrode assembly is located in a case 10 which preferably includes seals 11, 12 that surround the positive and negative electrode terminals 8, 9, respectively. An excess pressure emergency relief valve 13 is preferably also present to provide for operational safety and to facilitate filling of the device with electrolyte after placement of the electrode assembly in the case 10.

An aqueous sulfuric acid electrolyte is preferably used. The electrolyte resides in the pores of the positive and negative electrodes, and the separator.

During charge and discharge of the hybrid device D, the following redox reactions occur in its positive electrodes 1 and lead-acid battery (spongy lead) negative electrodes 2, respectively:

PbO₂+4H⁺+SO4²⁻+2e [symbol] PbSO₄+2H₂O (1)

Pb+SO₄²⁻ [symbol] PbSO₄+2e (2)

Likewise, the following processes occur in the HES (carbon) negative electrode 3 during its charge and discharge:

H⁺/e [symbol] H⁺+e (3)

In formula (3), H⁺/e represents the electric double layer (EDL) of the polarizable negative carbon electrode 3, which is formed during charging of the hybrid device from (H) protons and electrons (e) interacting with the protons by electrostatic forces.

During discharge of the hybrid device D there occurs an inverse process—that is, the breaking up of the EDL. In this inverse process, disengaged electrons pass to the positive electrode via the external electric circuit, while the protons pass to the electrolyte, thereby preserving its electric neutrality. After discharge of the hybrid device D there again occurs formation of an EDL at its polarizable carbon negative electrode 3. EDL electrons also pass to the polarizable negative carbon electrode 3 from the spongy lead negative electrodes 2, thereby causing a discharge thereof, while EDL protons pass from the electrolyte.

As shown, the hybrid device D includes a heterogeneous electrochemical supercapacitor and a lead acid battery, which share a common electrolyte and are packaged in a common case 10. The negative polarizable carbon electrode 3 with EDL is characterized by higher charge and discharge currents in comparison to the spongy lead negative electrodes 2 of the battery. During high power pulse discharges of the hybrid device D, the negative carbon electrode 3 and the positive electrode 1 adjacent thereto are discharged at the beginning of the discharge process. The spongy lead negative electrodes 2 are also partially discharged.

Right after disconnection of the discharge current, the potential of the polarizable carbon negative electrode 3 is more positive in value than the potential of the spongy lead negative electrodes 2. Consequently, right after completion of the discharge process, electrons from the spongy lead negative electrodes 2 move to the polarizable carbon negative electrode 3, decreasing the potential of and partially discharging the spongy lead negative electrodes. As a result of this process, the capacitor portion of the hybrid device D is charged, and the device is again ready for another discharge process. The number of discharge pulses possible without additional charging of the hybrid device D depends on the design of the device and on the parameters of the discharge pulse(s).

After the hybrid device D is discharged multiple times, its positive electrodes 1 and spongy lead negative electrodes 2 become partially discharged and a short charge of the device is required for their recharge. The duration and currents associated with charging of the hybrid device D depend on the design of the device and the depth of discharge of its positive electrodes 1 and spongy lead negative electrodes 2. Testing shows that along with an increase in the number of negative carbon electrodes plates (in relation to the number of positive electrode plates), the time required to charge a hybrid device of the present invention is substantially reduced in comparison to a lead acid battery of similar design.

For a starter application, as discussed above, it is appropriate to design a hybrid device so that the energy output of the capacitor portion is capable of performing one reliable start. This is acceptable because after the first start, only a short interval of time will be required for a full recharge of the capacitor.

By altering the number of negative polarizable carbon electrode plates, spongy lead negative electrode plates, and positive electrode plates, it is possible to build many variants of a hybrid device of the present invention. Thus, it is possible to create hybrid devices with different discharge powers and energies. Such an approach to the design of a hybrid device of the present invention makes it possible to substantially enhance the scope of its application. Two such variants of a hybrid device of the present invention can be seen in FIGS. 1b and 1c.

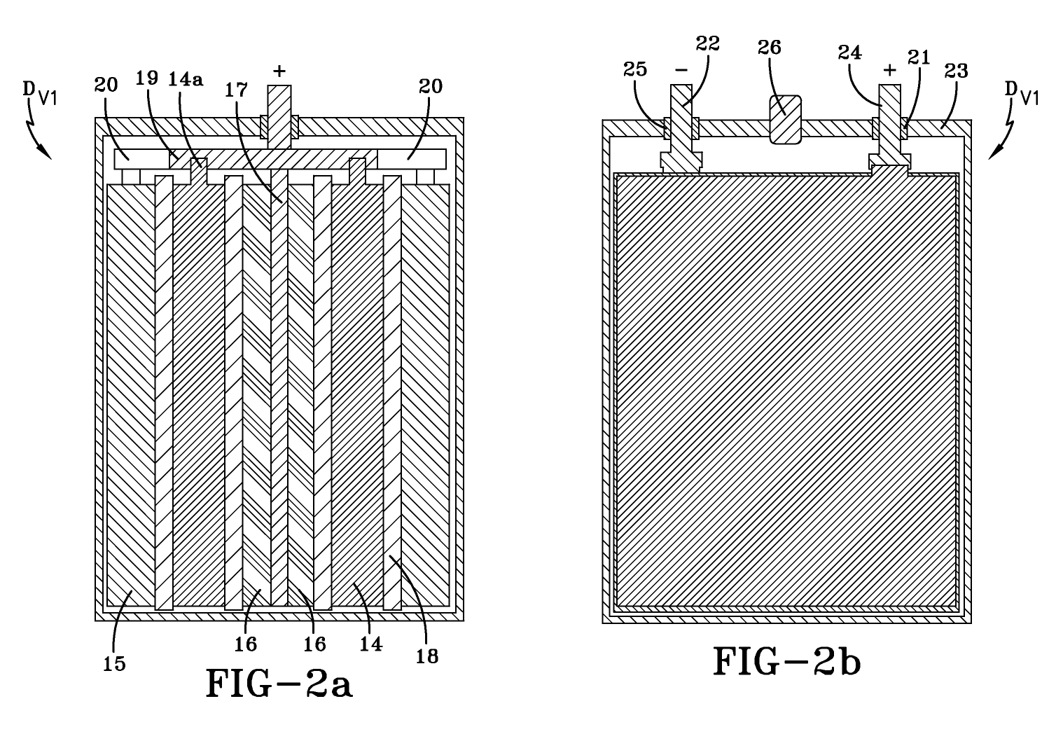

One illustrative variation of a hybrid device D_{V1} of the present invention can be observed in FIGS. 2a-2b. In this embodiment, a pair of positive electrodes 14 are again present. The positive electrodes 14 may again be made of lead dioxide (PbO₂) active material. The negative electrodes of the device D_{V1} include a pair of lead-acid battery negative electrodes 15, which may again be made of spongy lead active material, and a pair of HES negative electrodes 16, which may again be made of an active carbon material based on activated carbon powders and binding polymers.

A negative electrode current collector 17 is also present. The electrodes of the hybrid device D_{V1} are separated by porous separators 18. The current leads 14a of the positive electrodes 14 are preferably jumpered 19. The current leads 15a of the lead-acid battery negative electrodes 15 are also preferably jumpered 20.

The hybrid device D_{V1} has positive and the negative terminals 24, 22 that are connected to the jumpers 19, 20 of the positive and negative electrodes, respectively. The electrode assembly is located in a case 23 that preferably includes seals 21, 25 that surround the positive and negative electrode terminals 24, 22, respectively. An excess pressure emergency relief valve 26 is preferably also present. An aqueous sulfuric acid electrolyte is again preferably used.

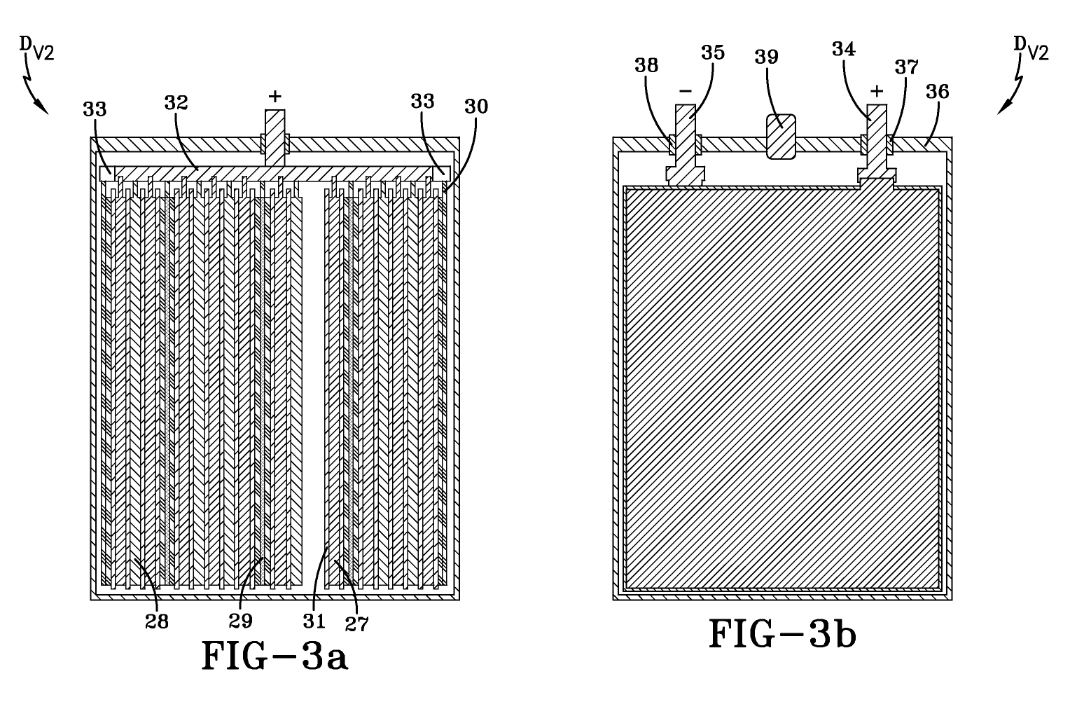

Another exemplary embodiment of a hybrid device D_{V2} of the present invention is shown in FIGS. 3a-3b. This embodiment represents how a hybrid device of the present invention can employ a large number of electrodes. As shown, a plurality of positive electrodes 27, spongy lead negative electrodes 28 and polarizable carbon negative electrodes 29 are arranged in a case 36 and impregnated with an aqueous sulfuric acid electrolyte.

The electrodes are separated by porous separators 31. The positive electrodes and negative electrodes are again connected by respective buses 32, 33. A positive terminal 34 and negative terminal 35 again extend through the case 36, and are preferably surrounded by seals 37, 38 to prevent leakage of the electrolyte. An excess pressure emergency relief valve 39 is preferably also present.

The balancing of the electric and electrochemical parameters of the polarizable carbon negative electrodes 29 and the spongy lead negative electrodes 28 is an important consideration in order to provide for the reliable and stable operation of a hybrid device of the present invention. In order to achieve high power parameters in a hybrid device of the present invention, the polarizable carbon negative electrode plates should have low Ohmic and ionic resistances.

Furthermore, as the carbon negative electrode(s) and spongy lead negative electrode(s) are connected in parallel, the overpotential of the hydrogen evolution of the carbon negative electrode(s) should be, at least, not lower than the overpotential of the hydrogen evolution of the spongy lead negative electrode(s). In the event of a low value of the overpotential of the hydrogen evolution of the carbon negative electrode(s), evolution of hydrogen will occur in the carbon negative electrode(s) after full charging of the capacitor portion of the hybrid device, and this process will be accompanied by discharge of the spongy lead negative electrode(s). As a result, the negative electrodes of a hybrid device of the present invention may be gradually discharged during extended periods. This gradual discharge can result in: (a) an imbalance of the capacities of the positive and negative electrodes; (b) a destabilization of the energy and power parameters of the device; and (c) a partial decomposition and loss of the electrolyte and a reduction of cycle life.

High-purity lead is preferably used to manufacture the active mass of the positive and negative electrodes of the lead-acid battery portions of hybrid devices of the present invention. This makes it possible to: (a) increase the overpotential of oxygen and hydrogen overpotential in the positive and negative electrodes, respectively; (b) reduce self-discharge currents; and (c) improve capacity parameters of the batteries.

The quantitative content of impurity atoms in the active material of the carbon polarizable negative electrode(s) is also an important factor for reliable operation of a hybrid device of the present invention. Most of the activated carbon powders currently used in the manufacture of polarizable carbon electrodes of symmetric and heterogeneous electrochemical capacitors contains various impurity atoms. While it is established that the presence of such impurity atoms in the carbon electrodes of an EDL capacitor does not, as a rule, considerably affect its parameters, the presence of the same atoms in the electrolyte of a hybrid device of the present invention can bring about an increase of its self-discharge current and destabilization of its energy and capacity parameters.

Apart from an increase in the self-discharge current, the presence of a certain concentration of particular impurity atoms in the carbon negative electrodes of a hybrid device of the present invention may also cause an increase of oxygen evolution in the positive electrode and hydrogen evolution in the negative electrode—which can impede the manufacture of sealed hybrid devices. The admixture atoms, which are contained in the carbon plates, may, during long term operation of such hybrid devices, be transferred to the electrolyte and be deposited on the surfaces of the positive (PbO₂) electrodes and spongy lead negative electrodes. This can cause a decrease in the overpotential of oxygen and hydrogen evolution of the electrodes.

Therefore, to ensure reliable operation of a hybrid device of the present invention, the concentration of admixture atoms in its carbon electrode plates (which decrease the overpotential of oxygen evolution in the positive electrode and hydrogen evolution in the negative electrode) should not be more than the concentrations of the one-type admixture atoms in the active materials of the positive (PbO₂) and the spongy lead negative electrodes of the hybrid device. The admixtures, which are most prevalent in the carbon materials and which have the greatest effect on self-discharge of the lead-acid battery portion of such a device, typically include admixture atoms of iron (Fe) and manganese (Mn). The maximum amount of Fe and Mn admixture in the carbon plates of a hybrid device of the present invention will depend on the design of the hybrid device and on the mass of its polarizable negative carbon electrode plates.

From the foregoing discussion, it can be understood that the present invention makes it possible to minimize the electric resistance of a “battery+capacitor” system, to increase the absolute and specific (by volume and mass) power and energy parameters of such a device, and to minimize the consumption of materials for its manufacture. It should also be noted that a hybrid device of the present invention can be produced using well-developed lead-acid battery manufacturing techniques, without any costly improvements thereto. Thus, it possible to significantly reduce the cost of such a hybrid device and to quickly and efficiently arrange for the production of such hybrid devices for a wide variety of applications.

### Specific Examples

### Example 1

In order to check the serviceability and identify the power and energy parameters of a hybrid device according to the present invention, a hybrid device HD#1 was manufactured in the form set forth in FIGS. 1a-1b. The hybrid device HD#1 includes two positive electrode plates 1 made of PbO₂, with approximate overall dimensions of 135 mm×72 mm×1.4 mm; two spongy lead negative electrode plates 2 with approximate overall dimensions of 135 mm×72 mm×1.8 mm; and one polarizable carbon negative electrode plate 3 with a mass density of 0.56 g/cm³, a specific electric capacitance of 620 F/g, a specific electric resistance of 2.6 Ohm·cm and approximate overall dimensions of 135 mm×72 mm×2 mm. The concentrations of Fe and Mn admixture atoms in the polarizable carbon negative electrode plate were determined to be about 56 ppm and 175 ppm, respectively. The hybrid device HD#1 also includes a current collector 4 associated with the polarizable carbon negative electrode 3. In this exemplary embodiment, the current collector 4 has approximate overall dimensions of 135 mm×72 mm×0.26 mm, and is made of lead alloy containing approximately 3% tin. A protective conducting coating is present on the current collector 4. An AGM-separator 5 of approximately 0.4 mm thickness resides between the electrodes.

After casting the jumpers (buses) 6 and terminals 8 of the positive electrodes 1, and the jumpers (buses) 7 and terminals 9 of the negative electrodes 2, the electrode assembly was placed in a case 10 with seals 11, 12 around the protruding positive and negative terminals 8, 9 of the electrodes, and an emergency relief valve 13 extends through the case. The electrodes and separators were impregnated with a rated amount of aqueous sulfuric acid electrolyte having a density of approximately 1.26 g/cm³.

For purposes of comparing the parameters of the hybrid device HD#1 with those of a lead-acid battery, a lead-acid battery LAB#1 was also manufactured. The lead-acid battery LAB#1 employs a PbO₂ positive electrode and spongy lead negative electrodes similar to those used in the hybrid device HD#1. Unlike the hybrid device HD#1, however, the lead-acid battery LAB#1 uses a third spongy lead negative electrode instead of a carbon negative electrode.

For the purpose of measurement of the power and energy parameters of the hybrid device HD#1 and the lead-acid battery LAB#1, charging of each was performed at a constant current of 0.53 A, while discharge occurred by currents of different values. During charging with a constant current of 0.53 A and discharge by a constant current of 0.45 A, it was established that the maximum value of Coulomb capacity and discharge energy for the hybrid device HD#1 was 6.1 A·h and 12.078 W·h, and for the lead-acid battery LAB#1, 8.355 A·h and 16.65 W·h.

Charging and discharge of the hybrid device HD#1 and lead-acid battery LAB#1 was performed under similar conditions for correct comparison of their energy and power parameters. In addition to charging at a constant current of 0.53 A, the value of the Coulomb capacity during every new charge was maintained at a level that was 1.2 times greater than the value of the Coulomb capacity of the hybrid device HD#1 and lead-acid battery LAB#1 as measured during their previous discharge. Discharge of the hybrid device HD#1 and lead-acid battery LAB#1 was performed when their voltage reached 1.7V (irrespective of the value of the discharge current).

Inasmuch as the values of the aggregate Coulomb capacity of the negative electrodes of the hybrid device HD#1 and lead-acid battery LAB#1 were different, correct comparison of the power parameters thereof requires an examination of the dependence of Coulomb capacity and discharge energy on the average specific power of discharge. These dependences are shown in the graphs of FIG. 2 and FIG. 3, respectively. The average specific power of discharge P was calculated by the following formula:

$$P = \frac{{E}_{d}}{{t}_{d} \cdot S} \qquad ( 4 )$$

Where: E_{d} is discharge energy; t_{d}=discharge time, and S=the work area of the non-polarizable spongy lead negative electrode. The work areas of the non-polarizable spongy lead negative electrodes used in the hybrid device HD#1 and lead-acid battery LAB#1 had values of S=291.6 cm² and S=388.8 cm², respectively.

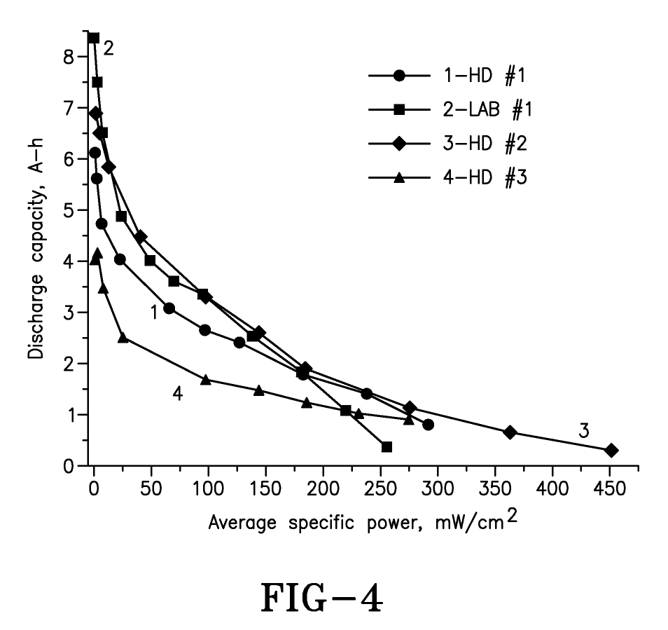

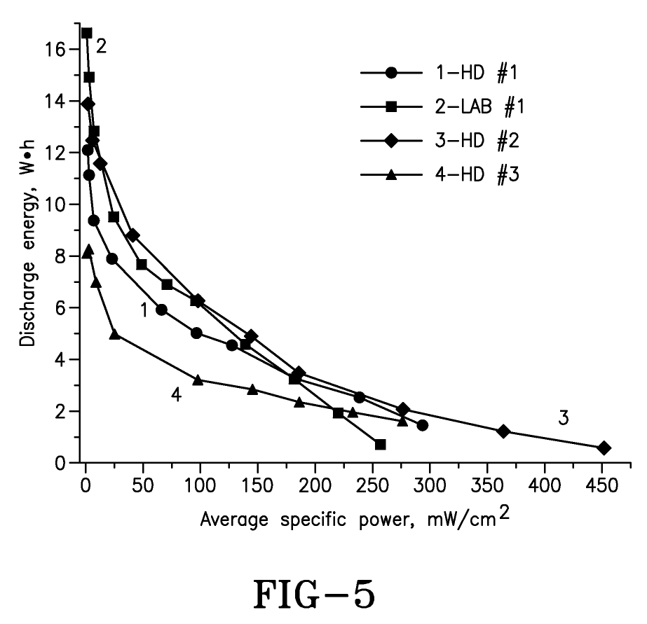

It can be observed in FIG. 4 and FIG. 5 that at low values of power of discharge of the hybrid device HD#1 and lead-acid battery LAB#1 (i.e., P<100 mW/cm²), the rate of decrease of discharge Coulomb capacity and discharge energy of the hybrid device HD#1 (curve 1) and the lead-acid battery LAB#1 (curve 2) are similar. The subsequent increase in the power of discharge of the hybrid device HD#1 and lead-acid battery LAB#1 shows that the Coulomb discharge capacity and discharge energy of the lead-acid battery LAB#1 decreases faster than the similar parameters of the hybrid device HD#1.

From these dependences, it is obvious that at a high discharge power of the hybrid device HD#1 and lead-acid battery LAB#1, the discharge energy of the hybrid device is greater than the discharge energy of the lead-acid battery. It should also be noted that the high power parameters of the hybrid device HD#1 are observed even though the hybrid device has a Coulomb capacity of 6.1 A·h, while the lead-acid battery LAB#1 has a Coulomb capacity of 8.355 A·h. Consequently, the hybrid device HD#1 is capable of providing high discharge power and will have a considerable advantage over the lead-acid battery LAB#1.

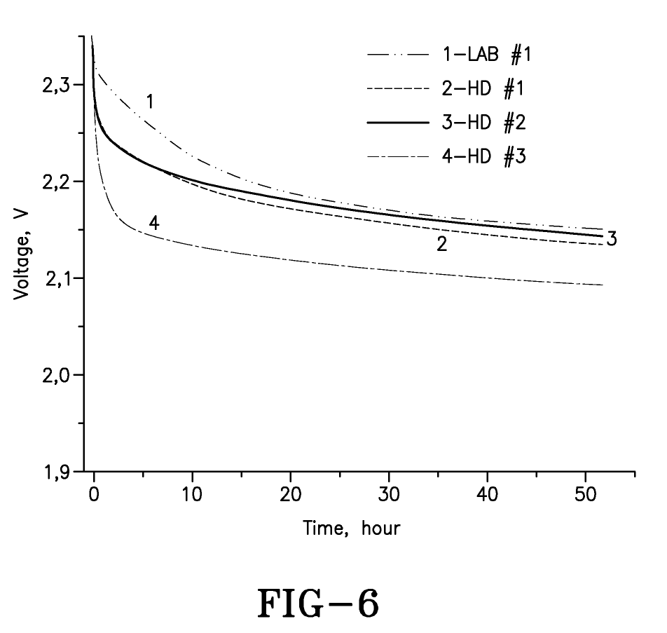

In order to evaluate the self-discharge currents of the hybrid device HD#1 and lead-acid battery LAB#1, a full charging thereof was performed after measurement of their energy and capacity parameters. The voltages of the hybrid device HD#1 and lead-acid battery LAB#1 were continuously measured immediately after the charging current was turned off, and during their storage at room temperature. The dependence of the voltages of the hybrid device HD#1 and lead-acid battery LAB#1 on the time of their storage is shown in FIG. 6.

It can be observed in FIG. 6 that the voltages of the hybrid device HD#1 (curve 2) and lead-acid battery LAB#1 (curve 1), measured immediately after the charging current was turned off, have values of approximately 2.35 V, a value that is substantially greater than the equilibrium voltage value (i.e., 2.17 V) of the lead-acid battery. This difference in voltages is related to the partial polarization of the positive and negative electrodes of the lead-acid battery that occurs at full charging thereof. The partial polarization brings about an increase of the voltage of the lead-acid battery LAB#1, and is accompanied by an increase in its polarization resistance and a decrease in its power parameters.

It can also be observed in FIG. 6 that the voltage of the hybrid device HD#1 rather quickly approaches the lead-acid battery LAB#1 equilibrium voltage value immediately after the charging current is turned off. Therefore, it can be understood that the polarization resistance of the hybrid device HD#1 immediately after its full charge is less than the polarization resistance of the lead-acid battery LAB#1. This further demonstrates the high power parameters of the hybrid device HD#1, even immediately after its full charge.

Upon initial storage of the hybrid device HD#1 and lead-acid battery LAB#1 immediately after charging thereof, the electrodes of both depolarize, which brings about a quick decrease in their voltages. The subsequent decrease of the voltage of the hybrid device HD#1 and lead-acid battery LAB#1 is determined only by the respective self-discharge thereof.

It follows from FIG. 6 that after the depolarization of the electrodes of the hybrid device HD#1 and lead-acid battery LAB#1, the self-discharge value of the hybrid device is greater than the self-discharge value of the lead-acid battery. The increased self-discharge value of the hybrid device HD#1 corresponds to the concentration of Fe and Mn admixtures in the carbon plate forming its polarizable negative electrode. When the concentration of Fe and Mn in the polarizable negative electrode is decreased (as shown below in Example 2) and/or when the number of spongy lead negative electrode plates is increased, the self-discharge value of the hybrid device HD#1 will also decrease.

Insofar as the depolarization of the electrodes in the hybrid device HD#1 occurs much faster than in the lead-acid battery LAB#1, it is obvious that the hybrid device is well suited to use in high-power pulse electric circuits—where the charge-discharge of a power supply is performed at a high rate.

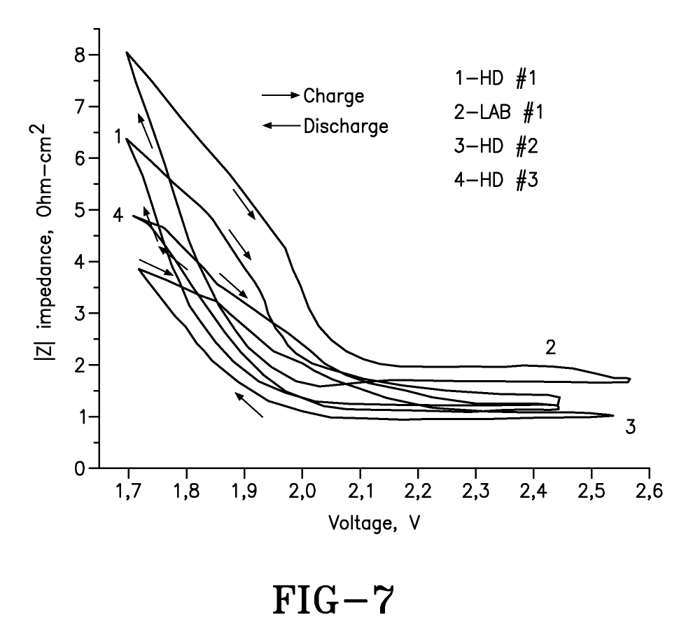

The measurements of impedance (z) dependence (at a cycle frequency ω=314 s⁻¹) of the hybrid device HD#1 and lead-acid battery LAB#1 on voltage during a 5 hour charge and discharge cycle are graphically illustrated in FIG. 7. As shown, the specific value of impedance |z| decreases during charging and increases during discharge of the hybrid device HD#1 and lead-acid battery LAB#1 (where |=|z|·S[Ohm·cm²]; |z| is the absolute value of impedance; and S=the work area of the non-polarizable spongy lead negative electrode). Furthermore, it can be seen that while changes in the specific impedance |Z| of the hybrid device HD#1 (curve 1) and lead-acid battery LAB#1 (curve 2) follow a similar pattern of behavior, the impedance of the hybrid device at the beginning of discharge has a value of approximately 1.3 Ohm·cm² while the corresponding impedance of the lead-acid battery is approximately 1.75 Ohm·cm². The impedance values of the hybrid device HD#1 and lead-acid battery LAB#1 at the end of discharge are about 6.64 Ohm·cm² and 8.06 Ohm·cm², respectively. It is the lower values of the specific |Z| impedance of the hybrid device HD#1 that help to produce its high power parameters.

### Example 2

A hybrid device HD#2 was manufactured as shown in FIGS. 2a-2b. The hybrid device HD#2 includes two positive electrode plates 14 made of PbO₂, with overall dimensions of approximately 135 mm×72 mm×1.4 mm; two spongy lead negative electrode plates 15 with overall dimensions of approximately 135 mm×72 mm×1.8 mm; and two polarizable carbon negative electrode plates 16 with a mass density of 0.65 g/cm³, a specific electric capacitance of 670 F/g, a specific electric resistance of 1.02 Ohm·cm and overall dimensions of approximately 135 mm×72 mm×1.2 mm. The concentrations of Fe and Mn admixture atoms in the polarizable carbon negative electrode plate were determined to be about 5 ppm and 14 ppm, respectively. The hybrid device HD#2 also includes a current collector 17 associated with the polarizable carbon negative electrodes 16. In this embodiment, the current collector 17 has overall dimensions of approximately 135 mm×72 mm×0.26 mm, and is made of lead alloy containing approximately 3% tin. A protective conducting coating is present on the current collector 17. An AGM-separator 18 of approximately 0.4 mm thickness resides between the electrodes.

After casting the jumpers (buses) 19 and terminals 24 of the positive electrodes 14, and the jumpers (buses) 20 and terminals 22 of the negative electrodes 15, the electrode assembly was placed in a case 23 with seals 21, 25 around the protruding positive and negative terminals 24, 22 of the electrodes, and an emergency relief valve 26 extends through the case. The electrodes and separators were impregnated with a rated amount of aqueous sulfuric acid electrolyte having a density of approximately 1.26 g/cm³.

To measure the power and energy parameters of the hybrid device HD#2, it was charged at a constant current of 0.57 A and discharged at constant currents with values in the range of between 0.35-50 A. Testing of the hybrid device HD#2 during charging at a constant current of 0.57 A and discharge at a constant current of 0.35 A showed the maximum value of its Coulomb discharge capacity to be about 6.882 A·h (see FIG. 4). The maximum discharge energy value was found to be approximately 13.86 W·h (see FIG. 5).

In order to obtain the dependencies of Coulomb discharge capacity and discharge energy of the hybrid device HD#2 on the average value of the specific power, separate discharges of the hybrid device HD#2 were performed at constant currents of different value until the voltage of the hybrid device reached 1.7V. The discharge of the hybrid device HD#2 at each individual value of the discharge current was performed when the cell voltage reached 1.7V. Recharging of the hybrid device HD#2 was performed at a constant current of 0.57 A. The value of the Coulomb capacity at each new charge of the hybrid device HD#2 was maintained at a level which was about 1.2 times greater than the value of the Coulomb capacity obtained during the preceding discharge.

The measurements of the dependence of the Coulomb capacity and discharge energy of the hybrid device HD#2 on the specific discharge power show that, at low discharge power values (e.g., P≦25 mW/cm²), the rates of decrease of the discharge Coulomb capacity (FIG. 4, curve 3) and discharge energy (FIG. 5, curve 3) are similar to the corresponding rates of decrease in the corresponding parameters of the lead-acid battery LAB#1. The increase in the discharge power of the hybrid device HD#2 illustrates that the Coulomb discharge capacity and discharge energy of the hybrid device decreases in a relatively slower manner than such decreases occur in the lead-acid battery LAB#1. At the average specific discharge power value P=451. mW/cm² (discharge current is 50 A), the values of the discharge Coulomb capacity and discharge energy of the hybrid device HD#2 are about 0.367 A19 h and 0.644 W·h, respectively. Consequently, it can be understood that the hybrid device HD#2 is capable of providing greater discharge energy during high power discharge than is the lead-acid battery LAB#1. Consequently, the hybrid device HD#2 is well-suited as a high discharge power source for various applications.

Observation of the dependence of hybrid device HD#2 voltage and lead-acid battery LAB#1 voltage on storage time shows that the changes in their voltages after electrode depolarization are similar (see FIG. 6, curve 1 vs. curve 3). This implies that the hybrid device HD#2 and the lead-acid battery LAB#1 exhibit similar self-discharge. It should be noted that, after completion of the charging process, the hybrid device HD#2 depolarizes in a faster manner than the lead-acid battery LAB#1 and will, therefore, provide for higher discharge powers immediately after completion of the charge process. It should also be noted that the lower level of self-discharge of this hybrid device HD#2 in comparison to the self-discharge characteristics of the first hybrid device HD#1 is related to the fact that this hybrid device HD#2 has a polarizable carbon negative electrode made from an active material with a lower content of Fe and Mn admixtures than that of the first hybrid device HD#1. The amount of Fe and Mn admixtures in the hybrid device HD#2 does not bring about an increase in the self-discharge thereof, as compared with the self-discharge of the lead-acid battery LAB#1.

An examination of the dependence of impedance |Z| of the hybrid device HD#2 on voltage during its charge and discharge reveals that the value of impedance |Z| at the beginning of discharge has a value of about 1.0 Ohm·cm², and increases to a value of about 3.85 Ohm·cm² at the end of discharge (see FIG. 7, curve 3). The lower value of impedance |Z| of the hybrid device HD#2 in comparison to the hybrid device HD#1 at the beginning of discharge is primarily determined by two factors. The first factor is that the hybrid device HD#2 employs a polarizable negative electrode active material with a lower specific electric resistance (1.02 Ohm·cm²) than the active material of the polarizable negative electrode of the hybrid device HD#1. The second factor is that the surface areas of the non-polarizable spongy lead negative electrode and the polarizable carbon negative electrode in the cell of the hybrid device HD#2 are greater than the surface areas of the corresponding electrodes of the hybrid device HD#1. As a result of its lower impedance |Z| value, discharge of this hybrid device HD#2 can occur at higher currents and can produce higher discharge powers in comparison to the first exemplary hybrid device HD#1.

After measurement of the power parameters of the hybrid device HD#2, multiple pulse discharges thereof were performed without any external recharging. The charged hybrid device HD#2 was initially discharged at a constant current of 30 A for 15 seconds. After completion of the first discharge pulse, there was a pause of 5 minutes, which was required for recharging of the capacitor portion of the hybrid device HD#2 from the battery portion thereof. Thereafter, a second discharge the hybrid device HD#2 was performed in the same manner to the first discharge pulse. This procedure was repeated many times until the voltage of the hybrid device HD#2 reached approximately 1.8 V (with the current at the end of discharge).

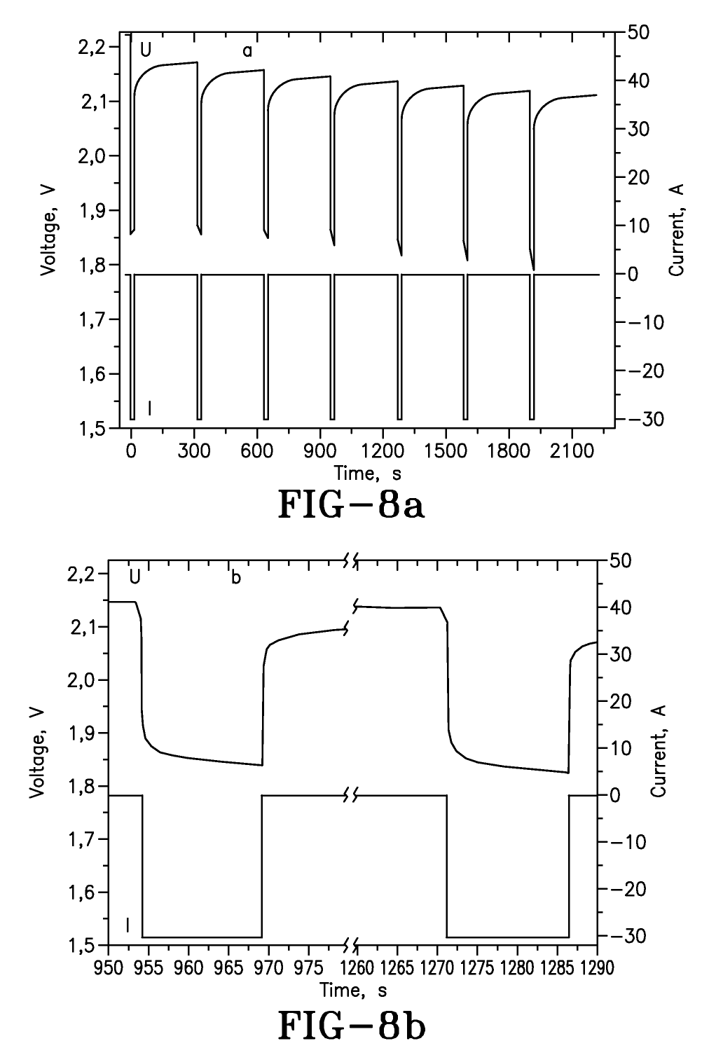

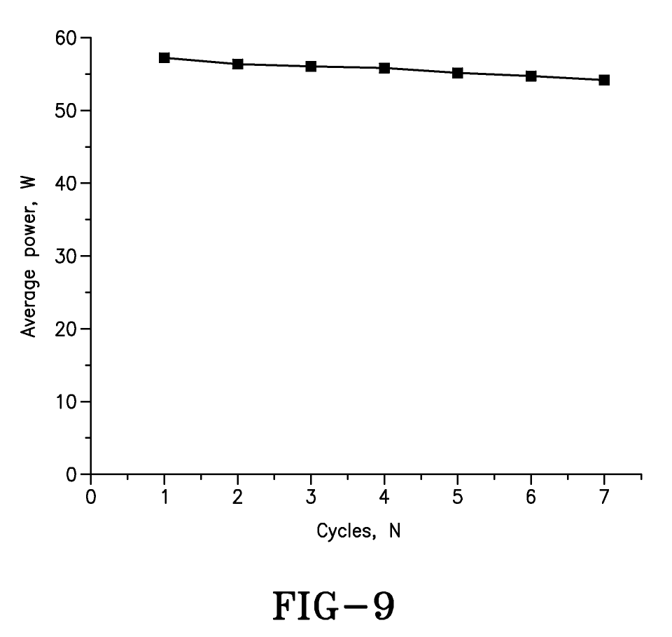

Subsequent testing of the hybrid device HD#2 after discharging as described above, showed that the voltage of the hybrid device reached 1.8 V (with the current at the end of discharge) after completion of seven discharge pulses (see FIG. 8). It follows, therefore, that along with an increase in the number of discharge pulses, the value of the voltage at the beginning of discharge of the hybrid device HD#2 decreases at a very slow rate to the value of the voltage at the end of discharge (see FIG. 8). Additionally, there also occurs a decrease in the value of the average power of the discharge pulses, although, as can be observed in FIG. 9, the average value of the power of the discharge pulses is only minimally affected by the number of completed discharge pulses. For example, the average power of the 1 st, 4th and 7th discharge pulses of the hybrid device HD#2 were measured at 57.36 W, 55.92 W and 54.46 W, respectively. This illustrates that after 7 consecutive discharges of the hybrid device HD#2, its average discharge power decreased by only 1.053 times.

As this example amply demonstrates, it is possible to output a number of consecutive discharge pulses of approximately similar power without charging a hybrid device of the present invention. As such, a hybrid device of the present invention is well-suited to use in, among other applications, high power pulse electric circuits.

### Example 3

In order to research the influence of the concentration of Fe and Mn admixture atoms contained in the polarizable carbon negative electrode on the energy and power parameters and on the self-discharge of a hybrid device of the present invention, an additional exemplary hybrid device HD#3 was constructed. A difference between the design of this hybrid device HD#3 and the first exemplary hybrid device HD#1 shown in FIGS. 1a-1b is that the end spongy lead negative electrode of the first hybrid device is replaced by a polarizable carbon negative electrode. Thus, the hybrid device HD#3 includes two positive electrode plates of PbO₂, one spongy lead negative electrode plate, and two polarizable carbon negative electrode plates. The electrodes of this hybrid device HD#3 have overall dimensions that are similar to the corresponding electrodes of the first hybrid device HD#1 as set forth in Example 1.

The mass density of the polarizable carbon negative electrodes is 0.52 g/cm³, the specific electric capacitance is 590 F/g, and the specific electric resistance is 2.3 Ohm·cm. The concentration of Fe and Mn admixture atoms in the polarizable carbon negative electrode active material was determined to be about 75 ppm and 210 ppm, respectively. The current collector of the polarizable carbon negative electrode is manufactured of lead alloy containing approximately 3% tin, and has a protective conducting coating. The hybrid device HD#3 uses AGM separators of about 0.4 mm thickness. The work surface area of a spongy lead negative electrode of this hybrid device HD#3 is about 194.4 cm². After assembly of the hybrid device HD#3, its electrodes and separators were impregnated with a rated amount of aqueous sulfuric acid electrolyte with a density of 1.26 g/cm³.

Testing of the energy and capacity parameters of the hybrid device HD#3 during charging at a constant current of 0.53 A and discharge at a constant current of 0.45 A were performed. The test results revealed that the Coulomb discharge capacity and discharge energy of the hybrid device HD#3 were 4.133 A·h and 8.192 W·h, respectively.

Research on the hybrid device HD#3 was performed (in a similar manner to that described in Examples 1 and 2) with respect to the dependences of its Coulomb discharge capacity and discharge energy on the average specific power of discharge. The results of this research indicates that the rates of decrease of the discharge capacity and energy of this hybrid device HD#3 approximate that of the first exemplary hybrid device HD#1, the second exemplary hybrid device HD#2, and the lead-acid battery LAB#1 at low powers of discharge (see FIG. 4, curve 4 and FIG. 5, curve 4). However, as shown in FIG. 5, at an average specific power of discharge P=225 mW/cm², this hybrid device HD#3 has a discharge energy greater than that of the lead-acid battery LAB#1. It can also be observed in FIG. 4 and FIG. 5 that provided P≦100 mW/cm², the rate of decrease of discharge energy of this hybrid device HD#3 is lower than the rate of decrease of the discharge energy of the first exemplary hybrid device HD#1. This again confirms that an increase of the work surface area of the polarizable carbon negative electrodes in relation to the work surface area of the spongy lead negative electrodes causes the power parameters of a hybrid device of the present invention to grow considerably. This example also again demonstrates that by changing the ratio of polarizable carbon negative electrode plates to non-polarizable spongy lead negative electrode plates, different variants of a hybrid device of the present invention can be quite easily produced having various different discharge powers and discharge energies.

As can be observed in FIG. 6 (curve 4), once the charging current is turned off, the voltage of this hybrid device HD#3 decreases in a prompt manner (i.e., the potentials of its positive and negative electrodes quickly depolarize). The voltage during self-discharge of this hybrid device HD#3 is of a value that is much smaller than the value of the voltage during the self-discharge of the first exemplary hybrid device HD#1, the second exemplary hybrid device HD#2, or the lead-acid battery LAB#1. Such behavior is primarily attributable to three factors. The first factor is that the active material of the polarizable carbon negative electrodes of this hybrid device HD#3 contain a greater amount of Fe and Mn admixture atoms than the active materials of the polarizable carbon negative electrodes of the first and second exemplary hybrid devices HD#1, HD#2. The second factor is that the ratio of the areas and/or mass of the polarizable and non-polarizable negative electrodes of this hybrid device HD#3 are greater than the corresponding ratios of the first and second exemplary hybrid devices HD#1, HD#2. The third factor is that a great amount of oxygen is evolved in the positive electrodes of this hybrid device HD#3 during charging, and the transfer of oxygen in the negative electrodes depolarizes it. Therefore, the voltage of the hybrid device HD#3 during self-discharge decreases faster than the similar voltages of the first and second exemplary hybrid devices HD#1, HD#2.

Insofar as the concentration of iron (Fe) and manganese (Mn) ions in the electrolyte of this hybrid device HD#3 is higher than the concentrations of the same admixtures in the electrolyte of the first and second exemplary hybrid devices HD#1, HD#2, the rate of oxygen recombination in the negative electrode of this hybrid device increases more dramatically along with the increase of the mass of the active material of the polarizable carbon negative electrode. This brings about a slight reduction of the overpotential of hydrogen evolution in the negative electrodes of this hybrid device HD#3 and an increase of its self-discharge. However, because the rate of oxygen recombination in this hybrid device HD#3 increases considerably, it is possible to charge a sealed hybrid device at high current densities without adversely affecting its sealed condition.

The dependence of the specific impedance |Z| of the hybrid device HD#3 on voltage is shown in FIG. 7 (curve 4). As can be seen, the values of impedance |Z| of the hybrid device HD#3 at the beginning and at the end of discharge are about 1.2 Ohm·cm² and 4.9 Ohm·cm², respectively. Insofar as the work surface areas of the polarizable carbon negative electrodes and non-polarizable spongy lead negative electrodes in this hybrid device HD#3 and the second exemplary hybrid devices HD#2 are similar, it is obvious that the lower impedance values |Z| of the second exemplary hybrid device HD#2 are attributable to the lower values of the specific electric resistance of the active material of its polarizable negative electrode. It can in fact be observed from multiple measurements of the specific impedances |Z| of various hybrid devices of the present invention (with different values of specific electric resistance of their polarizable carbon negative electrodes), that the power parameters of such hybrid devices significantly depend on the specific electric resistance of the polarizable carbon negative electrode used. Consequently, by manufacturing a polarizable carbon negative electrode using an active carbon material with a low specific resistance, it is possible to substantially increase the power parameters of a hybrid device of the present invention.

Various cells of a hybrid device of the present invention may be connected in parallel or in series. Various combinations of such cells may be used to manufacture different variants of a hybrid device of the present invention with high operating voltages and discharge powers.

Several exemplary hybrid devices of the present invention have been described in detail herein. These exemplary embodiments are set forth herein only to assist in adequately describing the benefits of a hybrid device of the present invention. However, nothing herein is to be construed as limiting a hybrid device of the present invention to a specific construction, or to the use of components of a particular material(s). For example, a multitude of different electrode combinations may be employed, and the electrodes, current collectors, separators and other components of a hybrid device of the present invention are not limited to those specifically described herein. Therefore, while certain embodiments of the present invention are described in detail above, the scope of the invention is not to be considered limited by such disclosure, and modifications are possible without departing from the spirit of the invention as evidenced by the following claims:

What is claimed is:

1. A hybrid electrical energy storage device having a lead-acid battery connected to an electric double layer electrochemical capacitor in a common case and sharing a common aqueous sulfuric acid electrolyte, said device further comprising:
at least one non-polarizable positive electrode;
at least one non-polarizable negative electrode;
at least one polarizable electric double layer negative electrode; and
separators residing between said electrodes.

2. The hybrid electrical energy storage device of claim 1, wherein said at least one non-polarizable positive electrode serves as a positive electrode of said lead-acid battery.

3. The hybrid electrical energy storage device of claim 1, wherein said at least one non-polarizable positive electrode includes lead dioxide.

4. The hybrid electrical energy storage device of claim 1, wherein said at least one non-polarizable negative electrode serves as a negative electrode of said lead-acid battery.

5. The hybrid electrical energy storage device of claim 1, wherein said at least one non-polarizable negative electrode includes lead.

6. The hybrid electrical energy storage device of claim 1, wherein said at least one polarizable negative electrode serves as a negative electrode of said electrochemical capacitor.

7. The hybrid electrical energy storage device of claim 1, wherein said at least one polarizable negative electrode is based on an activated carbon material(s).

8. The hybrid electrical energy storage device of claim 1, wherein said negative electrodes are electrically connected.

9. The hybrid electrical energy storage device of claim 1, wherein there are multiple positive electrodes and said positive electrodes are electrically connected.

10. The hybrid electrical energy storage device of claim 1, wherein said electrolyte impregnates said electrodes and said separator.

11. A hybrid lead-acid battery/electrochemical capacitor electrical energy storage device, comprising:
at least one non-polarizable positive electrode serving as a positive electrode of a lead-acid battery portion of said device;
at least one non-polarizable positive electrode serving as a positive electrode of an electrochemical capacitor portion of said device;
at least one non-polarizable negative electrode serving as a negative electrode of said lead-acid battery portion of said device;
at least one polarizable negative electrode serving as a negative electrode of said electrochemical capacitor portion of said device;
separators residing between said electrodes;
a positive electrode connector connecting said non-polarizable positive electrodes;
a negative electrode connector connecting said polarizable and non-polarizable negative electrodes;
an aqueous sulfuric acid electrolyte;
a common case housing said electrodes, said separators, said electrode connectors, and said electrolyte;
a positive terminal coupled to said positive electrode connector and extending through a wall of said case; and
a negative terminal coupled to said negative electrode connector and extending through a wall of said case.

12. The hybrid electrical energy storage device of claim 11, wherein said at least one non-polarizable positive electrode is comprised of lead dioxide.

13. The hybrid electrical energy storage device of claim 11, wherein said at least one non-polarizable negative electrode includes a spongy lead active material.

14. The hybrid electrical energy storage device of claim 11, wherein said at least one polarizable negative electrode is comprised of an activated carbon material.

15. The hybrid electrical energy storage device of claim 14, wherein said at least one polarizable negative electrode is further comprised of a polymer binder(s).

16. The hybrid electrical energy storage device of claim 11, further comprising a pressure relief valve extending through a wall of said case.

17. A hybrid lead-acid battery/heterogeneous electrochemical capacitor electrical energy storage device, comprising:
at least one non-polarizable lead dioxide positive electrode serving as a positive electrode of a lead-acid battery portion of said device;
at least one non-polarizable lead dioxide positive electrode serving as a positive electrode of an electrochemical capacitor portion of said device;
at least one non-polarizable lead-based negative electrode serving as a negative electrode of said lead-acid battery portion of said device;
at least one polarizable activated carbon-based negative electrode serving as a negative electrode of said electrochemical capacitor portion of said device;
porous separators residing between said electrodes;
a positive electrode connector connecting said non-polarizable positive electrodes;
a negative electrode connector connecting said polarizable and non-polarizable negative electrodes;
an aqueous sulfuric acid electrolyte impregnating said electrodes and said separators;
a common case housing said electrodes, said separators, said electrode connectors, and said electrolyte;
a positive terminal coupled to said positive electrode connector and extending through a wall of said case; and
a negative terminal coupled to said negative electrode connector and extending through a wall of said case.

18. The hybrid electrical energy storage device of claim 17, wherein said at least one non-polarizable lead-based negative electrode includes a spongy lead active material.

19. The hybrid electrical energy storage device of claim 17, wherein said at least one polarizable activated carbon-based negative electrode is comprised of an activated carbon powder and at least one polymer binder.

20. The hybrid electrical energy storage device of claim 17, further comprising a pressure relief valve extending through a wall of said case.
